(19) United States
(12) Patent Application Publication
(10) Pub. No.: US 2020/0097906 A1
(43) Pub. Date: Mar. 26, 2020

(54) DELIVERY MANAGEMENT SYSTEM AND METHOD

(71) Applicant: Ator Tetenta, Calgary AB (CA)

(72) Inventor: Ator Tetenta, Calgary AB (CA)

(21) Appl. No.: 16/143,392

(22) Filed: Sep. 26, 2018

(51) Int. Cl. G06Q 10/08; G06Q 50/18; H04L 29/08; H04L 12/58

(52) U.S. Cl. CPC G06Q 10/08345; H04L 51/24; H04L 67/306; G06Q 50/188

(57) ABSTRACT

A delivery management system and method including a software application for connecting delivery-drivers and users for transport of the at least one package. A delivery-cost is negotiated and determined by the delivery-driver and the user before delivery job acceptance. The system allows delivery-drivers to list available space and pick up/deliver multiple loads in a single route to maximize space usage and time. The application further allows users to post loads that need to be delivered.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of mobile applications of existing art and more specifically relates to delivery applications.

### RELATED ART

Modern delivery services offer a plethora of delivery choices for example, same day delivery, locker-based pickup, air, ground, charter, hand-carry, dedicated courier, alternative delivery services, and many others. The distinction between these choices can be difficult to discern for a typical consumer. As the number of choices increases, the difficulty of making a choice often increases. Effective commercial enterprises try to avoid confusing or overloading consumers. Accordingly, it would be advantageous to develop a system and methods for providing personalized delivery choices from amongst a wide range of delivery choices.

U.S. Pub. No. 2014/0025524 to Sims relates to examples of delivery and/or referral services that may use mobile enhancements and/or auction mechanisms. The described examples of delivery and/or referral services that may use mobile enhancements and/or auction mechanisms includes systems and methods that may relate to referral and/or delivery services. Some embodiments may include auctions and/or other ways of assigning service providers. Some embodiments may include mobile applications used by one or more participants in a delivery endeavor.

### SUMMARY OF THE INVENTION

In view of the foregoing disadvantages inherent in the known mobile application art, the present disclosure provides a novel delivery management system and method. The general purpose of the present disclosure, which will be described subsequently in greater detail, is to provide a delivery management system and method for efficient delivery of items using a mobile application to connect drivers with users in need of a delivery service.

A unique delivery management system is disclosed herein. The delivery management system includes a processor and a memory in communication with the processor. The memory has a database comprising a plurality of user accounts and a mobile device capable of accessing GPS and including a user-interface configured to enable communication with the server via a software application. The delivery management system includes a driver proximity locator configured to discover a driver to transport at least one package between desired locations. The software application of the delivery management system connects delivery-drivers and users for transport of the at least one package. A delivery-cost is negotiated and determined by the delivery-driver and the user before delivery job acceptance. The system allows delivery-drivers to list available space and pick up/deliver multiple loads in a single route to maximize space usage and time.

According to another embodiment, a method of using the delivery management system is also disclosed herein. The method of using the delivery management system includes the steps of providing a server including a processor and a memory in communication with the processor and the memory includes a database comprising a plurality of user accounts and a mobile device capable of accessing GPS and including a user-interface configured to enable communication with the server via a software application; registering a user account; posting a listing; connecting a delivery-driver and a user; negotiating a delivery-cost; accepting a delivery-job; and delivering at least one package.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a delivery management system and method, constructed and operative according to the teachings of the present disclosure.

FIG. 1 is a perspective view of the delivery management system and method during an ‘in-use’ condition, according to an embodiment of the disclosure.

FIG. 2 is a perspective view of the delivery management system and method of FIG. 1, according to an embodiment of the present disclosure.

FIG. 3 is a perspective view of the delivery management system and method of FIG. 1, according to an embodiment of the present disclosure.

FIG. 4 is a diagram illustrating features of the delivery management system and method of FIG. 1, according to an embodiment of the present disclosure.

FIG. 5 is a flow diagram illustrating a method of use for the delivery management system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile application and more particularly to a delivery application as used to improve the delivery of items by connecting drivers with users in need of delivery services.

Generally, delivery management system and method includes a mobile application for posting a load for transport and connecting a user with a delivery driver. The delivery-driver uses their personal vehicle for transporting goods. A price is negotiated by the user and the delivery driver and payment is made electronically through the application once a load is delivered. Empty return trips can be filled using the application; a delivery driver can simply list available space while in route to maximize trip efficiency and income potential. An additional feature for rating and commenting on delivery-drivers may be included in the mobile application. A zoom feature may be applied to the mobile application allowing a user to zoom in and look at photos uploaded to the mobile application.

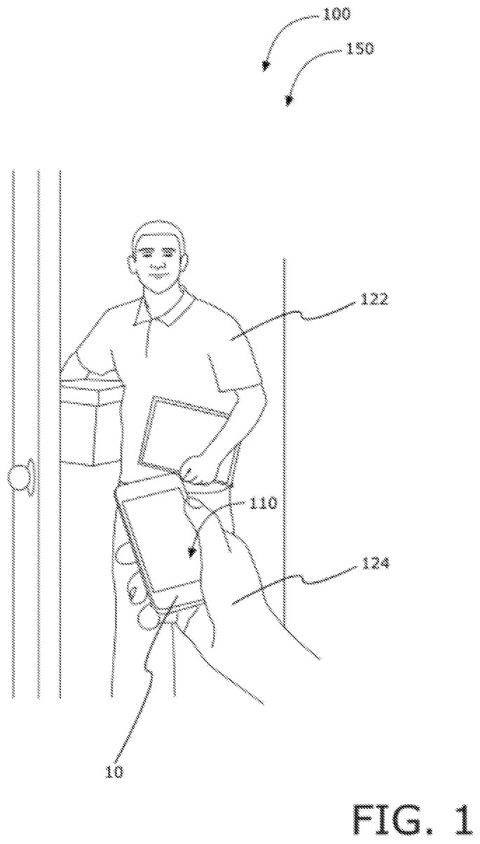

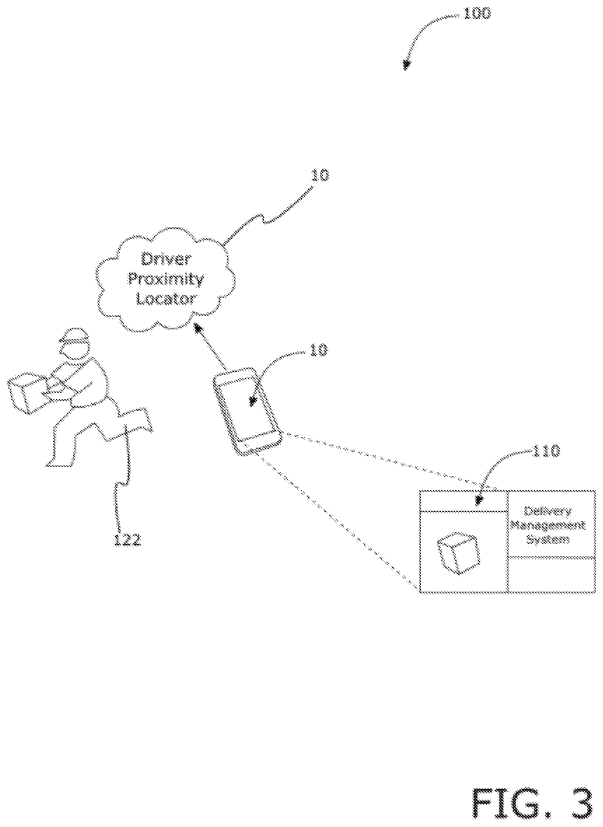

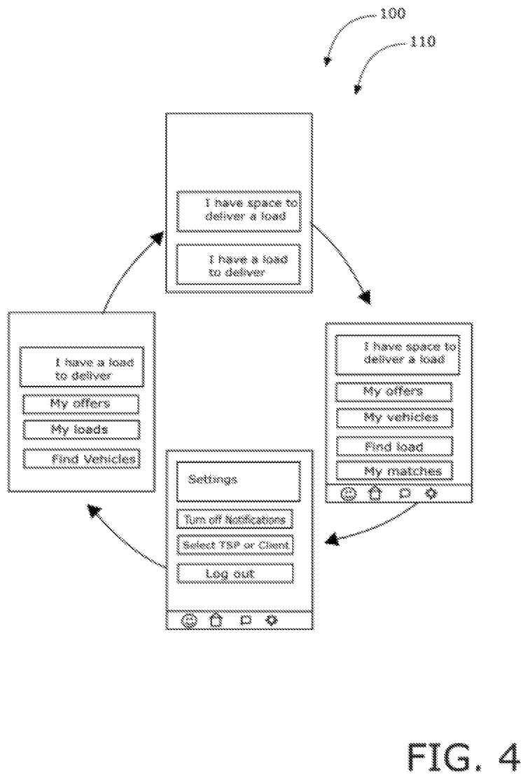

Referring now more specifically to the drawings by numerals of reference, there is shown in FIGS. 1-4, various views of a delivery management system 100. FIG. 1 shows a delivery management system 100 during an ‘in-use’ condition 150, according to an embodiment of the present disclosure. Here, the delivery management system 100 may be beneficial for use by a user to connect drivers and users for the delivery of items. As illustrated, the delivery management system 100 comprises a server including a processor and a memory in communication with the processor. The memory has a database comprising a plurality of user accounts and a mobile device 10 capable of accessing GPS and including a user-interface configured to enable communication with the server via a software application 110. The delivery management system 100 includes a driver proximity locator 120 configured to discover a delivery-driver 122 to transport at least one package between desired locations. The software application 110 of the delivery management system 100 connects delivery-drivers 122 and users 124 (load-owners) for transport of the at least one package. A delivery-cost is negotiated and determined by the delivery-driver 122 and the user 124 before delivery job acceptance. The delivery management system 100 allows delivery-drivers 122 to maximize deliveries and utilize the application 110 to list space available and pick up multiple items while in route.

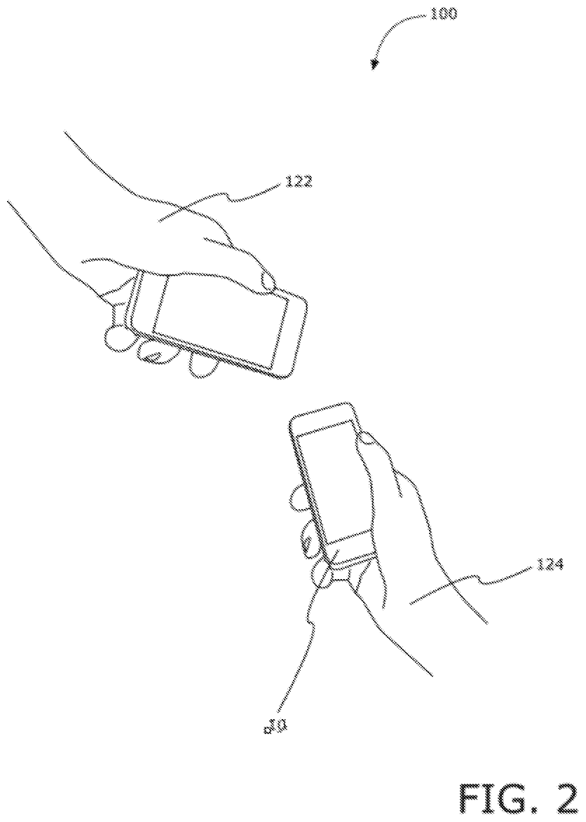

Referring now to FIGS. 2-4 showing various views of the delivery management system 100 of FIG. 1, according to an embodiment of the present disclosure. The software application 110 of the delivery management system 100 connects delivery-drivers 122 and users 124. The delivery management system 100 allows users 124 to post loads to deliver and further provides a platform for delivery-drivers 122 to post availability to deliver and transport loads. A delivery job is posted by one of the users in a listing form. The delivery job is accepted by one of the delivery-drivers 122. The delivery-cost is negotiable prior to acceptance of the delivery-job allowing the delivery-drivers 122 and the users 124 to negotiate the best deal. The plurality of user accounts includes user accounts created by the delivery-drivers 122 and the users 124. A pickup location is selected by the user. At least one package is trackable and location is viewable on the mobile device 10.

The software application 110 further includes a chat feature allowing the delivery-drivers 122 and the users 124 to communicate, negotiate prices and select pick up locations/delivery locations. The software application 110 is configured to provide visual or audio alert notifications. The alert notifications may include in-app or on-screen alerts and email alerts. In a preferred embodiment, the listing of the delivery job auto-expires within a predetermined amount of time. Users 124 can re-list items as needed. The listing of the delivery-job further includes a date and time setting. The listing includes a photo upload option, a written description of the delivery job, and a value of the load. The items of the delivery job may be insured. Disclaimer boxes may be included for certifying compliance with law and non-criminal use. The delivery management system 100 further includes a payment module integrated within the software application for payments between the delivery-drivers 122 and the users 124.

As a user 124 (load-owners), there are several ways to book a delivery-driver 122 after posting a listing. A ‘Find Vehicle’ feature may be included in the application 110 and user for finding a delivery-driver 122. The vehicle may be searched for using a vehicle ID or member ID. As another option, the user can wait for a delivery-driver 122 to approach. The delivery-drivers 122 are sorted by a plurality of filters to appropriately connect delivery-drivers 122 and users 124. The delivery-drivers 122 may be filtered by vehicle type and location in relation to the user 124. The delivery-drivers 122 or delivery service providers cannot accept loads until he or she has been verified. The delivery-drivers 122 may be required to upload vehicle documents and provide banking information for payments.

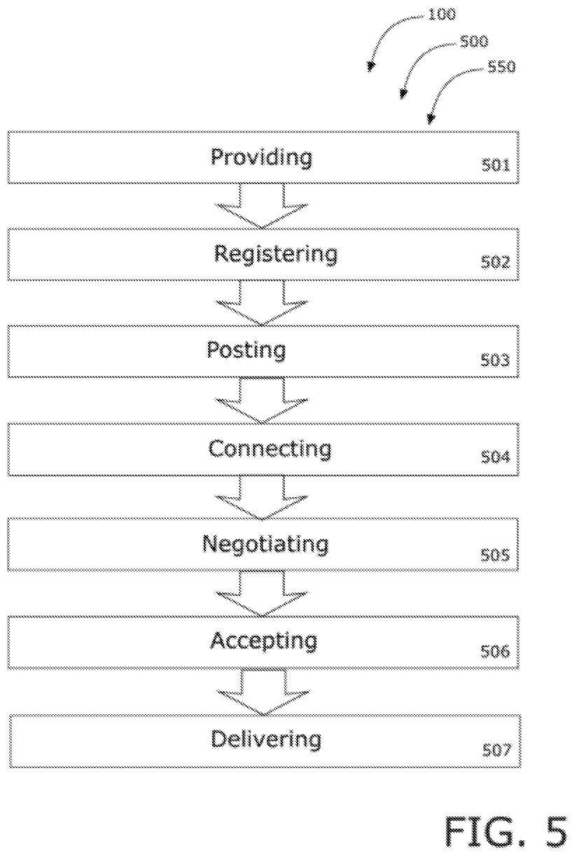

Referring now to FIG. 5 showing a flow diagram illustrating a method of use 500 for delivery management system 100, according to an embodiment of the present disclosure. In particular, the method of use 500 may include one or more components or features of the delivery management system 100 as described above. As illustrated, the method of use 500 may include the steps of: step one 501, providing a server including a processor and a memory in communication with the processor and the memory includes a database comprising a plurality of user accounts and a mobile device 10 capable of accessing GPS and including a user-interface configured to enable communication with the server via a software application 110; step two 502, registering a user account; step three 503, posting a listing; step four 504, connecting a delivery-driver 122 and a user 124; step five 505, negotiating a delivery-cost; step six 506, accepting a delivery-job; and step seven 507, delivering at least one package.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the delivery management system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A delivery management system comprising:
a server including:
a processor; and
a memory in communication with said processor, said memory having;
a database comprising a plurality of user accounts; and
a mobile device capable of accessing GPS and including;
a user-interface configured to enable communication with said server via a software application;
wherein said delivery management system includes a driver proximity locator configured to discover a driver to transport at least one package between desired locations;
wherein said software application of said delivery management system connects delivery-drivers and users for transport of said at least one package; and
wherein a delivery-cost is negotiated and determined by said delivery-driver and said user before delivery-job acceptance.

2. The delivery management system of claim 1, wherein a delivery job is posted by one of said users in a listing form.

3. The delivery management system of claim 2, wherein said delivery job is accepted by one of said delivery-drivers.

4. The delivery management system of claim 3, wherein said delivery-cost is negotiable prior to acceptance of said delivery-job.

5. The delivery management system of claim 1, wherein said plurality of user accounts includes user accounts created by said delivery-drivers and said users.

6. The delivery management system of claim 1, wherein said software application further includes a chat feature allowing said delivery-drivers and said users to communicate.

7. The delivery management system of claim 1, wherein said software application is configured to provide alert notifications.

8. The delivery management system of claim 7, wherein said alert notifications includes on-screen alerts and email alerts.

9. The delivery management system of claim 1, wherein said delivery-drivers are sorted by a plurality of filters.

10. The delivery management system of claim 9, wherein said plurality of filters includes vehicle type.

11. The delivery management system of claim 10, wherein said plurality of filters further includes location.

12. The delivery management system of claim 1, wherein said listing of said delivery job auto-expires.

13. The delivery management system of claim 1, wherein said listing of said delivery job further includes a date and time setting.

14. The delivery management system of claim 1, wherein said listing includes a photo upload option.

15. The delivery management system of claim 1, wherein said listing includes a written description.

16. The delivery management system of claim 1, wherein said delivery management system further includes a payment module integrated within said software application for payments between said delivery-drivers and said users.

17. The delivery management system of claim 1, wherein at least one package is trackable and location is viewable on said mobile device.

18. The delivery management system of claim 1, wherein a pickup location is selected by said user.

19. A delivery management system, the delivery management system comprising:
a server including:
a processor; and
a memory in communication with said processor, said memory having;
a database comprising a plurality of user accounts; and
a mobile device capable of accessing GPS and including;
a user-interface configured to enable communication with said server via a software application;
wherein said delivery management system includes a driver proximity locator configured to discover a driver to transport at least one package between desired locations;
wherein said software application of said delivery management system connects delivery-drivers and users for transport of said at least one package;
wherein a delivery-cost is negotiated and determined by said delivery-driver and said user before delivery job acceptance;
wherein a delivery job is posted by one of said users in a listing form;
wherein said delivery job is accepted by one of said delivery-drivers;
wherein said delivery-cost is negotiable prior to acceptance of said delivery-job;
wherein said plurality of user accounts includes user accounts created by said delivery-drivers and said users;
wherein said software application further includes a chat feature allowing said delivery-drivers and said users to communicate;
wherein said software application is configured to provide alert notifications;
wherein said delivery-drivers are sorted by a plurality of filters;
wherein said plurality of filters includes vehicle type;
wherein said listing of said delivery job auto-expires;
wherein said listing of said delivery job further includes a date and time setting;
wherein said listing includes a photo upload option;
wherein said listing includes a written description;
wherein said delivery management system further includes a payment module integrated within said software application for payments between said delivery-drivers and said users;
wherein at least one package is trackable and location is viewable on said mobile device; and
wherein a pickup location is selected by said user.

20. A method of use for the delivery management system, the method comprising the steps of:
providing a server including:
a processor; and
a memory in communication with said processor, said memory having;
a database comprising a plurality of user accounts; and
a mobile device capable of accessing GPS and including;
a user-interface configured to enable communication with said server via a software application;
registering a user account;
posting a listing;
connecting a delivery-driver and a user;
negotiating a delivery-cost;
accepting a delivery-job; and
delivering at least one package.
